(19) United States
(12) Patent Application Publication
(10) Pub. No.: US 2005/0049853 A1
(43) Pub. Date: Mar. 3, 2005

(54) Frame loss concealment method and device for VoIP system

(76) Inventors: Mi-Suk Lee, Daejeon-city (KR); Eung-Don Lee, Daejeon-city (KR); Do-Young Kim, Daejeon-city (KR); Hong-Kook Kim, Daejeon-city (KR); Seung-Ho Choi, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/932,397

(22) Filed: Sep. 1, 2004

(30) Foreign Application Priority Data
Dec. 26, 2003 (KR) 10-2003-0097769
Sep. 1, 2003 (KR) 10-2003-0060724

(51) Int. Cl. G10L 19/00

(52) U.S. Cl. 704/201

(57) ABSTRACT

Disclosed is a packet (frame) loss concealment method and device for a VoIP system, for reducing speech quality degradation caused by packet loss generated when transmitting speech data through a packet network. When a packet loss occur, the speech signal of the lost frame are reconstruct by combing the forward and backward prediction from the good frame before and after the lost frame Thus, speech quality of a speech coder can be improved without any extra delay in packet loss condition.

### CROSS REFERENCE TO RELATED APPLICATION

This application claims priority to and the benefit of Korea Patent Application No. 2003-97769 filed on Dec. 26, 2003 in the Korean Intellectual Property Office, the entire content of which is incorporated herein by reference.

### BACKGROUND OF THE INVENTION

(a) Field of the Invention

The present invention relates to a packet (frame) loss concealment (PLC) method and device for reducing quality degradation caused by packet loss, which could occur when transmitting speech data over a packet network.

(b) Description of the Related Art

Voice over IP (VoIP) applications such as IP telephony continues to gain popularity. In VoIP systems, one or several encoded speech data are grouped into a packet for the transmission through packet networks. FIG. 1 shows the speech data transmission in a packet network. The packet network for most VoIP systems operate based on RTP/UDP/IP, but they do not have any quality of service (QoS) control mechanism. Thus, packet (frame) losses could occur due to network congestion. A packet loss is also declared when the packet has not been arrived yet within the delay time of a playout buffer on the receiver side. When a packet loss rate exceeds a given threshold, received speech becomes unintelligible. To reduce the quality degradation caused by packet losses, there have several approaches been developed that are categorized by adaptive multimedia, QoS control in the Internet, forward error correction and packet loss concealment, and partial packet discard in ATM networks.

Among above several methods, our invention related to the packet loss concealment (PLC). A packet loss results in more than one frame losses depending on the packet size, but a PLC algorithm is realized by repeating a frame loss concealment algorithm as may times as packet size. Therefore, the terminologies of packet and frame appear with same meaning in a view of a concealment algorithm. The PLC algorithms can be classified into the sender-based algorithm and the receiver-based algorithm with regard to the place where the concealment algorithm works. The sender-based algorithms, e.g., forward error correction (FEC), are more effective than receiver-based algorithms but require additional bits used for being processed in the decoder when packet losses occur. On the other hand, the receiver-based algorithms including the repetition based forward PLC and the interpolative PLC have advantages over the sender-based algorithms since they do not need any additional bits, and thus the already existing standard speech encoders can be used without any modification.

In the forward PLC (F-PLC) algorithms, the parameters of the lost current frame are estimated by extrapolating those of the previous good frame. That is, the parameters of the lost frame estimated by repeating the down-scaled version of the previous ones. The PLC algorithm used in ITU-T G.729 that is widely used for VoIP belongs to this category. The specific steps taken for reconstructing a lost frame in G.729 are 1) repeating the synthesis filter parameters, 2) attenuating adaptive and fixed codebook gains followed by attenuating the memory values of the gain predictor, and 3) randomly generating the excitation. This approach works well under wireless communication environments where the delay is an essential issue so there is no time to wait for the future good frames in the receiver.

FIG. 2 shows the basic idea of the repetition based F-PLC algorithm. In the figure, the n-th and (n+1)-th frames are lost. The F-PLC algorithm approximates the parameters of the n-th and (n+1)-th frames by repeating the parameters of the (n−1)-th frame with down-scaling. The performance of F-PLC depends on the degree of correlation between the previous good frame and the lost frame. Thus, if the frames are consecutively erased, the performance degradation of F-PLC is related to the duration of frame loss.

It is assumed in a VoIP system that a future good frame is available in the playout buffer just after a series of lost frames. Based on this assumption, an interpolative PLC (I-PLC) algorithm was proposed by using a future good frame that is available in the playout buffer just after a series of lost frames. Thus, this I-PLC algorithm could reconstruct a lost frame by interpolating the parameters of the previous and future good frames. However, it has been applied only to estimate the adaptive codebook parameters of G.729, while the other parameters including line spectral frequencies (LSF), fixed codebook gains and indices were obtained by using the forward PLC algorithm described in the previous paragraph. Nevertheless, the interpolative PLC algorithm gave better speech quality than the forward PLC algorithm.

I-PLC algorithm utilizes the information of the future good frame stored in playout buffer as shown in FIG. 3, where the parameters of the n-th and (n+1)-th frames are estimated by linearly interpolating those of the (n−1)-th and (n+2)-th frames. I-PLC provides better performance than F-PLC, but it has difficulties in estimating the parameters of the lost frames, especially when the lost frames are from the transient regions of speech.

In VoIP system, CELP-based speech coders are widely used for speech compression. However, the CELP coders are generally known to be sensitive to both bit errors and packet losses. To reduce the quality degradation without the bit rate increase, speech decoders should include a PLC algorithm

### SUMMARY OF THE INVENTION

A speech packet loss concealment (PLC) algorithm for improving voice quality in VoIP systems is provided. As shown in FIG. 1, the playout buffer for reducing the effects caused by delay jitter is an essential component of all VoIP receivers, and it plays a main role in proposing a PLC algorithm. By assuming that the size of the playout buffer is enough to store at least one future good frame, this good frame to improve the speech quality can be used under a packet loss condition without any extra delay. In fact, this assumption can be accepted most of time.

It is advantages of the present invention to provide a PLC algorithm and device for effectively reconstruct the speech signal of the lost frame by combing forward and backward prediction based on the closest good frame to lost frames in VoIP systems. The proposed PLC algorithm estimates the parameters of the lost frames based on the closest frame among the previous and the future good frames of the lost frame because adjacent frames have higher correlation than the two frames apart.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a block diagram for voice data transmission over packet network for description of a preferred embodiment of the present invention;

FIG. 2 shows a conventional repetition-based forward PLC algorithm employed in ITU-T G.729;

FIG. 32 shows a conventional interpolative PLC algorithm based on VoIP systems;

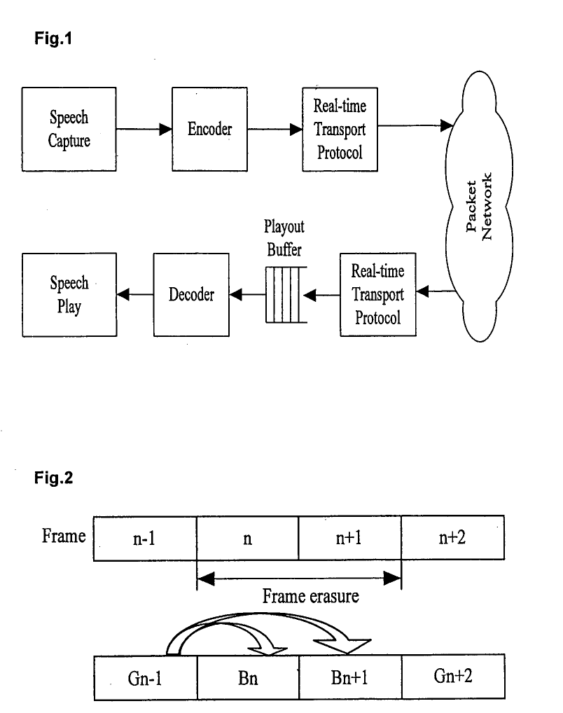

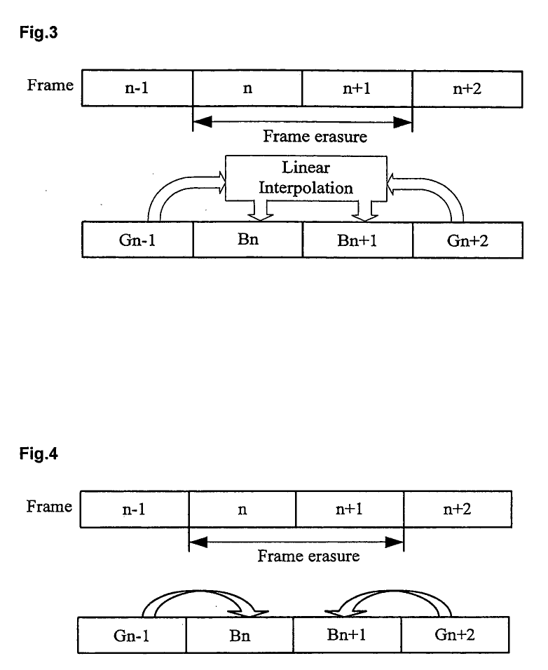

FIG. 4 shows a conceptual diagram of a forward-backward PLC method for the VoIP system according to a preferred embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

The CELP-based encoders represent speech signal as spectral envelope and excitation, and then quantize them for the transmission. The low bit-rate speech coders are able to achieve toll-quality performance by exploiting the correlation between adjacent analysis frames when quantizing the coding parameters. By incorporating this property into PLC processing, a forward-backward PLC (FB-PLC) algorithm is provided. FIG. 4 demonstrates the basic idea FB-PLC. In the figure, the n-th and (n+1)-th frames are lost. Therefore, a PLC algorithm is needed to reconstruct the n-th and (n+1)-th frames.

The proposed FB-PLC algorithm estimates the parameters of the lost frames from the adjacent frame among the previous and the future good frames because adjacent frames have higher correlation than the two frames apart. FIG. 4 shows an example of the FB-PLC procedure. The n-th frame is reconstructed from the (n−1)-th frame (forward concealment) because the (n−1)-th frame is closer to the n-th frame than the (n+2)-th frame. Similarly, the (n+1)-th frame is reconstructed from the (n+2)-th frame (backward concealment). The procedure of estimating the parameters of the n-th frame by using the forward prediction in FB-PLC is different from that in F-PLC in that the estimates of parameters are bounded by the estimates of the backward prediction. Similarly, the estimates of the (n+1)-th frame parameters are obtained by the backward prediction and bounded by the result of the forward prediction.

In ITU-T G.729, the proposed FB-PLC algorithm is implemented in a frame basis for LSF, but in a subframe basis for pitch and codebook parameters. The parameters of a lost frame are estimated by forward and backward prediction based on the parameters of the closest good frame. When the number of lost frames is even, each half of the frames are estimated by using the previous or the future good frames close to each lost frame. On the other hand, when it is odd, the LSF parameters for the center frame in the lost frames are approximated by averaging the forward and backward prediction parameters from both the previous and future good frames. However, such a problem in estimating pitch and codebook parameters is not generated because the number of subframes during the lost frames is equally divided by half even if the number of the lost frames is odd.

The FB-PLC, F-PLC, and modified version of I-PLC into G.729 are applied, and the performance of FB-PLC is compared to their performance in terms of the objective and subjective quality. Even though the I-PLC algorithm was implemented only for the pitch parameter, the interpolation procedure is extended to the estimation process of LSF and codebook gain. It turned out to be that this approach gave the better performance than the original form of the I-PLC algorithm. This approach will be referred to as modified I-PLC (MI-PLC) hereinafter.

To evaluate the objective and subjective quality of the PLC algorithms, 8 Korean sentences spoken by 8 speakers (4 males and 4 females) are prepared from the NTT-AT database. Each sentence was 8 second long and was sampled at 16 kHz, followed by down-sampling to 8 kHz using the ITU-T G.191 software tool.

ITU-T P.862 (PESQ) was used as a measure of the objective quality for each PLC algorithm and the results were summarized in Table 1. The PESQ score for a CELP-based coder was known to be correlated with the perceptual quality measured by mean opinion score (MOS). In this experiment, the VoIP channel is modeled as a randomly erased channel with a different frame erasure rate (FER) from 1% to 15%. In order to evaluate the robustness of PLC algorithms to the burst frame erasure, the packet size was set to 10, 20, and 30 ms. Table 1 shows the PESQ scores of the conventional and proposed PLC algorithms. MI-PLC achieved better PESQ scores than F-PLC. However, the FB-PLC algorithm gave the best performance under all the FER conditions. What is interesting in the table is that the PESQ score is not always degraded as the packet size increases, especially when the FER is low. In addition, it is important to give an emphasis on the point that the proposed FB-PLC achieved significantly better performance for larger packet size and higher FER than F-PLC and MI-PLC.

In addition, AB-preference tests between MI-PLC and FB-PLC are performed under a frame erasure of 5%. To process the speech sentences with a more general frame erasure pattern, the frame erasure insertion tool in G.191 was used. In the experiments, the burstiness of the channel was set to 0.7, and the maximum number of consecutive frame loss was restricted to three. These processed four female and four male sentence pairs were presented to 9 listeners in a randomized order. Table 2 shows the relative preference of FB-PLC to MI-PLC. The proposed FB-PLC algorithm was significantly preferred over the MI-PLC algorithm.

TABLE 1
PESQ scores for each PLC algorithm

| Packet | PLC | Frame loss rates (%) | | | | | |
|---|---|---|---|---|---|---|---|
| size | Type | 1 | 3 | 5 | 7 | 10 | 15 |
| 10 | F-PLC | 3.67 | 3.38 | 3.24 | 3.09 | 2.91 | 2.72 |
| | MI-PLC | 3.69 | 3.46 | 3.32 | 3.20 | 3.04 | 2.84 |
| | FB-PLC | 3.71 | 3.50 | 3.39 | 3.28 | 3.13 | 2.92 |
| 20 | F-PLC | 3.62 | 3.27 | 3.09 | 2.93 | 2.70 | 2.52 |
| | MI-PLC | 3.65 | 3.35 | 3.17 | 3.03 | 2.81 | 2.63 |
| | FB-PLC | 3.68 | 3.42 | 3.30 | 3.16 | 3.02 | 2.78 |
| 30 | F-PLC | 3.62 | 3.30 | 2.99 | 2.81 | 2.60 | 2.32 |
| | MI-PLC | 3.65 | 3.42 | 3.13 | 2.97 | 2.80 | 2.52 |
| FB-PLC | 3.70 | 3.47 | 3.21 | 3.09 | 2.93 | 2.74 | |

TABLE 2
Performance test results for the MI-PLC and the proposed
FB-PLC algorithm at 5% FER.

Preference Score (%)

| Speaker | MI-PLC | FB-PLC |
|---|---|---|
| Female | 33.33 | 66.67 |
| Male | 30.56 | 69.44 |

1. In a packet loss concealment method for reconstructing the speech signals of a lost frame, a packet loss concealment method for a VoIP (Voice over Internet Protocol) system comprising:
a) detecting a lost frame:
b) determining a frame closest to the lost frame from the good frames before and after the lost frame; and
c) predicting the data of the lost frame by using the determined frame data and reconstructing the speech signals.

2. The method of claim 1, wherein c) comprises predicting the lost frame data by forward prediction from the good frame data just before the lost frame and bounding the prediction results by the result of backward prediction.

3. The method of claim 1, wherein c) comprises predicting the lost frame data by backward prediction from the good frame data just after the lost frame and bounding the prediction result by the result of forward prediction.

4. The method of claim 1, wherein when the frames are consecutively lost, the respective lost frames are sequentially reconstructed by using the frame data closest the lost frame from good frame data before and after the lost frame.

5. In a packet loss concealing device for reconstructing the lost speech signals, a packet loss concealing device for a VoIP (voice over Internet protocol) system comprising:
a playout buffer for storing arrived frame data, transmitting the frame data to a decoder at a predefined time interval, and transmitting the data and time information of the closest frame to the lost frame;
a decoder for reconstructing speech signals according to the received frame type (bad or good frame), and predicting the lost frame data by using the frame data adjacent the lost frame from the good frame data before and after the frame loss; and
a BFI (bas frame indicator) for representing whether a frame loss occurs.

6. The device of claim 5, wherein the decoder comprises:
a decoding module for reconstructing good frame data; and
a packet loss concealment module for reconstructing the speech signal of the lost frame, receiving good frame data just before and after the lost frame from playout buffer, selecting a frame closest to the lost frame, predicting the lost frame data by combing forward and backward prediction, and reconstructing speech signals.
